(19) United States
(12) Patent Application Publication
(10) Pub. No.: US 2024/0140208 A1
(43) Pub. Date: May 2, 2024

(54) ELECTRIC MOTOR ASSEMBLY

(71) Applicant: ECOFILE LTD, Finedon, Northamptonshire (GB)

(72) Inventor: David Leroy HATFIELD, Finedon, Northamptonshire (GB)

(21) Appl. No.: 18/278,875

(22) PCT Filed: Mar. 11, 2022
(86) PCT No.: PCT/GB2022/050635

§ 371 Date: Aug. 25, 2023

(30) Foreign Application Priority Data
Mar. 16, 2021 (GB) 2103626.4
Feb. 23, 2022 (GB) 2202491.3

(51) Int. Cl. B60L 50/61; B60L 50/13; B60L 50/14; B60L 50/51; B60L 58/12; B60L 58/18

(52) U.S. Cl. CPC B60L 50/61; B60L 50/13; B60L 50/14; B60L 50/51; B60L 58/12; B60L 58/18; B60L 2210/30; B60L 2210/44

(57) ABSTRACT

A propulsion apparatus for an electric vehicle including both a drive motor and a generator configured to recover energy from the vehicle drivetrain. The invention also relates to an energy supply and storage system suitable for use with a propulsion apparatus having a drive motor and generator, and to an electric vehicle having a powertrain including such a propulsion apparatus.

### FIELD OF INVENTION

The present invention relates to electric motor assemblies, and in particular electric motor assemblies suitable for use as a propulsion apparatus in road vehicles, unmanned and manned aerial vehicles and watercraft.

### BACKGROUND ART

Electric vehicles have significant environmental advantages over conventional fossil fuel powered vehicles and are becoming increasingly common as individuals, businesses and governments seek to reduce harmful emissions associated with transport. Compared to internal combustion engines, electric motors have fewer moving parts and are less susceptible to damage, reducing maintenance costs and increasing the lifetime of the vehicle. Electric vehicles are typically quieter in operation and therefore reduce noise pollution.

Currently, electric road vehicles typically use lithium-ion (Li-ion) or lithium polymer batteries. Although significant progress has being made in recent years, it remains the case that electric road vehicles typically have lower range than petrol/diesel vehicles, take longer to recharge (compared to refilling a fuel tank) and the availability of recharging points (particularly those capable of rapid charging) is limited. Increasing vehicle range requires either larger batteries (which increases vehicle weight) or using an alternative (and possibly less proven) type of battery with increased energy storage capacity. Alternative battery technologies often give increased energy storage capacity at the expense of other factors such as maximum current output, battery longevity, cost, safety and cold/hot weather performance.

Although increasing battery size may be possible up to a point for road vehicles, this is not always possible for other types of electric vehicles such as aircraft, owing to size and weight limits. Battery technologies with higher energy density (i.e. higher energy storage per unit of weight) may not yet be suitable for use in vehicles owing to safety concerns or prohibitive costs. There is therefore a need to improve the range of electric vehicles using current battery technology without relying on increased battery size.

Although purpose-built electric vehicles are becoming increasingly common, it is unlikely that the entire fleet of conventional internal combustion powered vehicles will be replaced in the short term. More modern or specialist conventional internal combustion powered vehicles may remain perfectly serviceable or be too expensive to replace with a new purpose-built electric vehicle. In these cases it may be desirable to retrofit conventional vehicles with an electric powertrain to prolong their life whilst ensuring they meet updated environmental regulations. Conventional vehicles which have been retrofitted to have electrically powered drive currently have range issues owing to the limited available space for batteries.

### SUMMARY OF THE INVENTION

Viewed from a first aspect the present invention provides propulsion apparatus for an electric vehicle, comprising: a drive motor having a rotor mounted on and extending annularly around a motor shaft, and a stator spaced apart from the rotor and extending annularly around the rotor and at least a portion of the motor shaft, wherein the motor shaft has a first end, a second end and a longitudinal axis extending therebetween and is connectable to a drivetrain of a vehicle; a generator having a rotatable part mounted on and extending annularly around a generator shaft, and a fixed part spaced apart from the rotatable part and extending annularly around the rotatable part and at least a portion of the generator shaft, wherein the generator shaft has a first end, a second end and a longitudinal axis extending therebetween and is connected to and is driveable by the motor shaft, and wherein either the rotatable part or the fixed part is capable of generating a magnetic field, and an armature is provided on the alternate fixed part or rotatable part; and a support structure to support the drive motor, the generator, the motor shaft and the generator shaft, wherein the stator and the fixed part are mounted to the support structure and the support structure includes one or more bearings to support and limit lateral movement of the motor shaft and generator shaft.

By connecting the generator shaft to the motor shaft, the generator shaft is rotated when the drive motor rotates the motor shaft. As the motor shaft provides drive power to the drivetrain of the vehicle, the generator shaft is also rotated, causing an electric current to be generated in the armature of the generator. This generated current can then be stored (for example in a battery) and later used to provide power to the drive motor. The generator therefore provides the means to recover energy from the vehicle powertrain to increase vehicle range.

By mounting the drive motor and generator on a support structure, the propulsion apparatus can advantageously be provided as a single motor unit for installation in existing vehicles. For example, the propulsion apparatus can replace a conventional internal combustion engine and can be mounted within the vehicle and connected to the vehicle drivetrain in place of the conventional engine. This enables the propulsion apparatus to be retrofitted to existing vehicles.

The one or more bearings may be plain bearings, roller-element bearings, fluid bearings or magnetic bearings.

The size, operating voltage and power output of the drive motor and generator can be selected according to the required application. For road vehicles such as cars and vans, the drive motor may operate at 120 V or more, for example at 400 V. For boats, bicycles and motorcycles the drive motor may operate at 48 V or more. For fixed wing aircraft the drive motor may operate at 120 V or more. For rotary wing aircraft such as helicopters the drive motor may operate at 700 V or more, for example at 1500 V. The generator preferably has an output voltage of 220-240 V.

The drive motor may have conductive coil or other element suitable for carrying an electric current disposed on or within the rotor, whilst having either a permanent magnet or an electromagnet (e.g. a field coil) disposed on or within the stator. Alternatively the drive motor may have a conductive coil or other element suitable for carrying an electric current disposed on or within the stator, whilst having either a permanent magnet or an electromagnet (e.g. a field coil) disposed on or within the rotor. In operation, an electric current applied to the conductive coil interacts with the magnetic field of the permanent magnet or electromagnet to generate torque on the motor shaft.

The generator may have a conductive coil or other element suitable for carrying an electric current such as an armature winding disposed on or within the rotatable part, whilst having either a permanent magnet or an electromagnet (e.g. a field coil) disposed on or within the fixed part. Alternatively the generator may have a conductive coil or other element suitable for carrying an electric current such as an armature winding disposed on or within the fixed part, whilst having either a permanent magnet or an electromagnet (e.g. a field coil) disposed on or within the rotatable part.

The generator shaft may be spaced apart from and substantially parallel to the motor shaft. The generator shaft may be connected to the motor shaft via a pulley and belt, a sprocket and chain or one or more gears.

Preferably the second end of the motor shaft is connected to the first end of the generator shaft (i.e. the motor shaft and generator shaft are conjoined) such that the motor shaft and generator shaft are coaxial. In this configuration the first end of the motor shaft may be connectable directly to the drivetrain of the vehicle. Alternatively the second end of the generator shaft may be connectable to the drivetrain of the vehicle such that the motor shaft is connectable to the drivetrain via the generator shaft.

Compared to using a belt and pulley, chain and sprocket or gear system to connect the motor shaft to the generator shaft, positioning the motor shaft and generator shaft coaxially reduces the number of components and the complexity of the propulsion apparatus. This reduces the likelihood of the apparatus failing (for example by chain stretching, gear wear or belt failure). Direct coaxial mounting of the generator shaft on the motor shaft also reduces the load on the drive motor and ensures that the generator shaft rotates at the same speed as the motor shaft.

Particularly preferably the motor shaft and generator shaft are a single unitary elongate body (i.e. formed as a single shaft) comprising a motor shaft portion adjacent to the rotor and a generator shaft portion adjacent to the rotatable part. A single unitary shaft has a lower chance of failure (e.g. by shearing or separation of the generator and motor shafts) and is simpler to manufacture.

Preferably where the motor shaft and generator shaft are coaxial or are formed as a single unitary elongate body, the motor shaft and generator shaft are supported by a first bearing positioned longitudinally between the drive motor and generator, a second bearing positioned longitudinally between the drive motor and the first end of the motor shaft, and a third bearing positioned longitudinally between the generator and the second end of the generator shaft.

Preferably the drive motor and generator are spaced apart longitudinally (where the motor shaft and generator shaft are coaxial) and/or transversely (if the motor shaft and generator shaft are not coaxial) to minimise magnetic field interaction between the drive motor and generator.

The support structure may include a magnetic field shield positioned between the motor and the generator. The magnetic field shield is composed of a material having a high magnetic permeability, for example iron, nickel, cobalt or alloys containing these metals. The first bearing may be provided on the magnetic field shield.

Preferably the magnetic field shield is composed of steel. The required composition and thickness of the magnetic field shield depends on the size of the motor and/or generator and can be readily determined in practice. Preferably the magnetic field shield is composed of a material and has a thickness sufficient to prevent >99% of the magnetic flux from the drive motor and/or generator passing through to the other side of the magnetic field shield.

Where the motor shaft and generator shaft are coaxial and the support structure does not include a magnetic field shield, a separation distance between the rotor and rotatable part is preferably equal to or greater than a longitudinal length of the rotor. Where the motor shaft and generator shaft are coaxial and the support structure includes a magnetic field shield, a separation distance between the rotor and rotatable part is preferably equal to or greater than 25% of the longitudinal length of the rotor.

The generator may be a permanent magnet generator with either the rotatable part or the fixed part comprising a permanent magnet and the alternate part providing the armature. For example the rotatable part may comprise the permanent magnet whilst the fixed part comprises the armature. Alternatively the fixed part may comprise the permanent magnet whilst the rotatable part comprises the armature.

The propulsion apparatus may further comprise a fan attached to either the motor shaft or the generator shaft. In use, as the drive motor rotates the motor and generator shafts, the fan increases airflow over the drive motor, generator and support structure to enhance cooling.

The support structure may be a housing to house the drive motor, generator and at least a portion of the motor shaft and the generator shaft. The housing preferably encloses all or a majority of the drive motor and generator. This helps to minimise dirt, debris or other foreign objects entering, damaging or reducing the efficiency of the drive motor and generator. Preferably an end portion of the motor shaft and/or the generator shaft protrudes from the housing for connection to a vehicle drivetrain.

The housing may have one or more heat sinks on an external surface. The heat sinks may be ridges, ribs, pins, dimples or pegs and may be integrally formed with the housing or attached to the external surface of the housing. The heat sinks are composed of a material having high thermal conductivity such as a metal. The heat sinks may be provided in addition to or instead of a fan connected to the motor or generator shaft. The housing may also be provided with a liquid coolant conduit which extends through or over the housing from an inlet port to an outlet port. The inlet and outlet ports are connectable to a liquid coolant system.

The propulsion apparatus may further comprise an energy supply and storage system which comprises: a first battery bank; a second battery bank; and a control unit electrically connected to the first battery bank, the second battery bank, the drive motor, and the generator, and connectable to a throttle control; wherein the control unit can direct electrical power from one of the first battery bank or the second battery bank to the drive motor in response to a power demand signal from the throttle control, and can simultaneously direct electrical power from the generator into the alternate battery bank.

The control unit can monitor and control current flow from each of the first and second battery banks independently and can provide power from either battery bank to a load circuit including the drive motor. The control unit can also monitor and direct current flow from a generator circuit including the generator into either battery bank. The control unit may include a CPU and a memory capable of monitoring and storing information such as battery charge state and temperature.

The first and second battery banks may comprise lithium-ion batteries, nickel-metal hydride batteries or any other type of battery applicable to electric vehicles. Preferably both the first and second battery banks are of the same type and capacity. The capacity of the battery banks can be selected according to the desired application. For road vehicles such as a car or light goods vehicle, the capacity of each battery bank may be between 5 and 150 kWh. For an electric bicycle or motorcycle, the capacity of each battery bank may be between 2 and 20 kWh. For aircraft such as helicopters, the capacity of each battery bank may be between 20 and 150 kWh. The output voltage of the battery banks can also be selected according to the desired application and the drive motor used.

The generator may be either a DC or an AC generator. The generator may be a DC generator and further comprise a mechanical or electronic commutator which is electrically connected to the armature to convert the current generated in the armature to direct current. Alternatively the generator may be an AC generator and the propulsion apparatus further comprises a rectifier electrically connected between the generator and the control unit to convert the generated alternating current to direct current for storage in a battery. The energy supply and storage system may further comprise a step-up or step-down charger electrically connected between the control unit and the generator, or between the control unit and each of the first and second battery banks to adjust the voltage to match the battery voltage.

The control unit may include a first amp hour meter to determine a charge level for the first battery bank; and a second amp hour meter to determine a charge level for the second battery bank; wherein the control unit is configured to be switchable between a first operational mode wherein the first battery bank provides power to the drive motor and the second battery bank is charged by the generator, and a second operational mode wherein the second battery bank provides power to the drive motor and the first battery bank is charged by the generator, when the charge level in the battery bank providing power to the drive motor reaches a predetermined value as detected by one of the amp hour meters. The predetermined value is preferably a charge level of between 10% and 30%, or more preferably a charge level of between 20% and 30%, or even more preferably a charge level of about 25%.

Viewed from a second aspect the present invention provides an electric vehicle having a powertrain which includes: a propulsion apparatus comprising a drive motor mounted on a motor shaft, wherein the motor shaft has a first end, a second end and a longitudinal axis extending therebetween; a generator mounted on a generator shaft, wherein the generator shaft has a first end, a second end and a longitudinal axis extending therebetween and is connected to and is driveable by the motor shaft; and a support structure to support the drive motor, the generator, the motor shaft and the generator shaft, wherein the support structure includes one or more bearings to support and limit lateral movement of the motor shaft and generator shaft; and a drivetrain connected to and driveable by the motor shaft.

Preferably the second end of the motor shaft is connected to the first end of the generator shaft such that the motor shaft and generator shaft are coaxial. The drivetrain may be connected directly to the first end of the motor shaft. Alternatively the drivetrain may be connected to the second end of the generator shaft such that the drivetrain is connected to the motor shaft via the generator shaft.

Particularly preferably the motor shaft and generator shaft are a single unitary elongate body (i.e. formed as a single shaft) comprising a motor shaft portion and a generator shaft portion. The drivetrain may be connected to a first end of the elongate body/single shaft adjacent the motor shaft portion or may be connected to a second end of the elongate body/single shaft adjacent the generator shaft portion.

The vehicle drivetrain may be any drivetrain including conventional drivetrains used in internal combustion powered vehicles. The propulsion apparatus may be connected directly to a prop shaft or drive shaft of the drivetrain. Alternatively the propulsion apparatus may be connected to a transmission such as a gearbox or transaxle. The propulsion apparatus may also be connected to a clutch or flywheel. Unlike internal combustion engines, electric motors can generate 100% of their torque at low speeds. There may therefore be no need for a clutch or transmission. However the propulsion apparatus can be connected directly to and is compatible with an existing vehicle drivetrain (which may include a clutch and transmission). This advantageously allows a conventional vehicle to be retrofitted as an electric vehicle without requiring replacement of the entire drivetrain.

The electric vehicle may further comprise an energy supply and storage system, wherein the energy supply and storage system comprises a first battery bank; a second battery bank; and a control unit electrically connected to the first and second battery banks, the drive motor, the generator and a throttle control provided on the vehicle; wherein the control unit can direct power from one of the battery banks to the drive motor in response to an input from the throttle control whilst simultaneously directing power from the generator to the alternate battery bank.

The electric vehicle may be a land-based vehicle (such as a bicycle, motorcycle, car, van, multi-purpose vehicle, bus, coach, light goods vehicle, heavy goods vehicle or off-road vehicle), a marine vessel (such as a dinghy, launch, motorboat, ship or submarine), or an aircraft (such as a rotary-wing aircraft, fixed wing aircraft or unmanned aerial vehicle). A rotary-wing aircraft may have a main rotor and a tail rotor (c.f. a conventional helicopter) or may have any number of rotors. The rotors may be the same or different sizes. Multiple rotors may be mounted coaxially (i.e. to rotate around the same axis) or coplanar (i.e. to rotate in the same plane). For example, a rotary-wing aircraft may have four rotors in a quadrotor configuration with four coplanar rotors or may have eight rotors in a double quadrotor configuration with four pairs of contra-rotating coaxial rotors.

The electric vehicle may include one or multiple powertrains as hereinbefore described. For example a rotary-wing aircraft or unmanned aerial vehicle may have a quadrotor configuration with each rotor powered by its own powertrain.

Where a vehicle has multiple powertrains, each powertrain may have its own energy supply and storage system. Alternatively the vehicle may have a single energy supply and storage system which provides power to each powertrain. Each drive motor and generator may be independently electrically connected to the control unit and the control unit may be configured to control the amount of power provided to each drive motor independently. This is particularly advantageous for quadrotor configurations as the differing thrust from each rotor is used to adjust yaw and pitch.

Where the electric vehicle is a land-based vehicle and has at least one drive axle, the drivetrain may comprise a prop shaft which is connected to and is driveable by the motor shaft and which extends longitudinally with respect to the vehicle from the propulsion apparatus to a differential at the drive axle. Preferably the prop shaft and the motor shaft are coaxial.

Where the electric vehicle is a land-based vehicle having at least one drive axle, the drivetrain may comprise a transmission which is connected to and is driveable by the motor shaft. The transmission may include a clutch, flywheel, gearbox and/or a transaxle. Where the land-based vehicle has more than one drive axle, the drivetrain may include a transfer case.

Viewed from a third aspect the present invention provides an energy supply and storage system for an electric vehicle, comprising: a first battery bank; a second battery bank; and a control unit electrically connected to the first battery bank and the second battery bank, wherein the control unit also includes a power output port, a power input port and a controller port; wherein in use the control unit can direct electrical power from one of the first battery bank or the second battery bank to the power output port in response to a demand signal from a controller connected to the controller port, and can simultaneously direct electrical power from the power input port into the alternate battery bank.

The control unit may include: a first amp hour meter to determine a charge level for the first battery bank; and a second amp hour meter to determine a charge level for the second battery bank; wherein the control unit is switchable between a first operational mode wherein the first battery bank provides power to the power output port and the second battery bank receives power for recharging from the power input port, and a second operational mode wherein the second battery bank provides power to the power output port and the first battery bank receives power for recharging from the power input port, when the power remaining level in one or both of the battery banks reaches a predetermined value.

### BRIEF DESCRIPTION OF DRAWINGS

A specific implementation of the present invention will now be described, by way of example only, and with reference to the accompanying drawings in which:

FIG. 1 is a perspective view of a propulsion apparatus according to the present invention.

FIG. 2 shows a longitudinal cross-section of the propulsion apparatus of FIG. 1.

FIG. 3 shows a longitudinal cross-section of a similar propulsion apparatus to FIG. 1, which further includes a fan and cooling fins.

FIG. 4 shows an exploded view of a road vehicle powertrain including the propulsion apparatus of FIG. 1.

FIG. 5 is a plan view of a road vehicle having the powertrain of FIG. 4.

FIG. 6 is a simplified plan view of a fixed-wing multi-engine aircraft having the propulsion apparatus of FIG. 1.

FIG. 7 is a simplified plan view of a fixed-wing single-engine aircraft having the propulsion apparatus of FIG. 1.

FIG. 8 is a side view of a boat having the propulsion apparatus of FIG. 1.

FIG. 9 is a plan view of a boat having the propulsion apparatus of FIG. 1.

FIG. 10 is a plan view of a quadrotor type rotary wing aircraft having the propulsion apparatus of FIG. 1.

FIG. 11 is a simplified circuit diagram showing an energy supply and storage system according to the present invention and electrical connection to the propulsion apparatus of FIG. 1.

FIG. 12 is a graph showing battery charge levels over time for a propulsion apparatus of FIG. 1 attached to an electric tricycle and powered by the energy supply and storage system of FIG. 11.

FIG. 13 is a graph showing battery voltages over time for a propulsion apparatus of FIG. 1 attached to an electric tricycle and powered by the energy supply and storage system of FIG. 11.

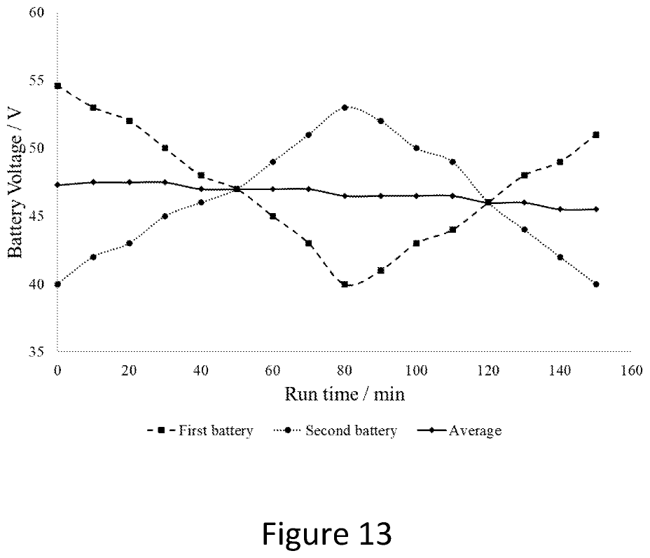

### DETAILED DESCRIPTION OF PREFERRED EMBODIMENT OF THE INVENTION

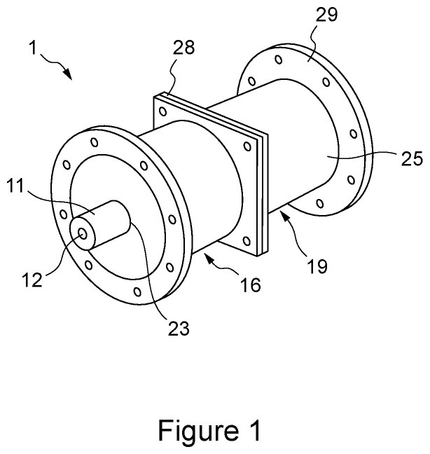

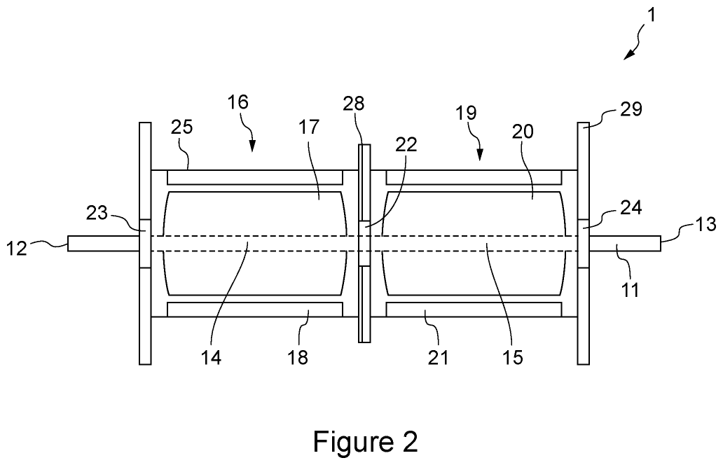

Referring initially to FIGS. 1 and 2, a propulsion apparatus 1 is shown. The propulsion apparatus 1 is a contained motor unit and is intended to replace a conventional internal combustion engine within a vehicle. The propulsion apparatus 1 has an elongate shaft 11 having a first end 12 and a second end 13. The shaft 11 defines a longitudinal axis (not shown). A drive motor 16 and a generator 19 are positioned on the shaft 11 at a motor shaft portion 14 and a generator shaft portion 15 respectively.

The drive motor 16 includes a rotor 17 which is mounted on and extends annularly around the motor shaft portion 14, and a stator 18 which is spaced apart from and extends annularly around the rotor 18. The drive motor 16 is a conventional electric motor, and the type, voltage and power rating can be selected according to the desired application.

The generator 19 includes a rotatable part 20 which is mounted on and extends annularly around the generator shaft portion 15, and a fixed part 21 which is spaced apart from and extends annularly around the rotatable part 20. In this particular embodiment, the generator 19 is a permanent magnet synchronous generator and the rotatable part 20 includes a neodymium (NdFeB) permanent magnet. The fixed part 21 includes an armature winding in which a current is induced by the rotation of the permanent magnet.

In this particular embodiment, both the drive motor 16 and the generator 19 are enclosed by a housing 25. The housing prevents dirt, debris or moisture entering the gaps between the rotor 17 and stator 18, and rotatable part 20 and fixed part 21. Dirt, debris or moisture could clog or corrode key components of the drive motor 16 or generator 19, reducing their lifetime or efficiency.

The shaft 11 is partially enclosed within the housing 25, with the motor shaft portion 14 and the generator shaft portion 15 being within the housing 25. The shaft 11 extends outside the housing 25 at it's first end 12 and second end 13 to allow connection to other components of a vehicle drivetrain. The shaft 11 is supported by a first bearing 22 positioned between the drive motor 16 and the generator 19, a second bearing 23 positioned between the drive motor 16 and the first end 12 of the shaft 11, and a third bearing 24 positioned between the generator 19 and the second end 13 of the shaft 11. In this particular embodiment the bearings 22, 23 and 24 are ball bearings.

The drive motor 16 and the generator 19 are spaced apart longitudinally by a distance approximately equal to 25% of the longitudinal length of the drive motor 16. This is to reduce interaction between the adjacent magnetic fields of the drive motor 16 and the permanent magnet of the generator 19. The housing 25 is further equipped with a steel plate magnetic field shield 28 mounted between the drive motor 16 and generator 19. This further reduces interaction between the magnetic fields of the drive motor 16 and the generator 19.

The housing 25 includes a flange 29 at each end to enable the propulsion apparatus 1 to be mounted in a vehicle.

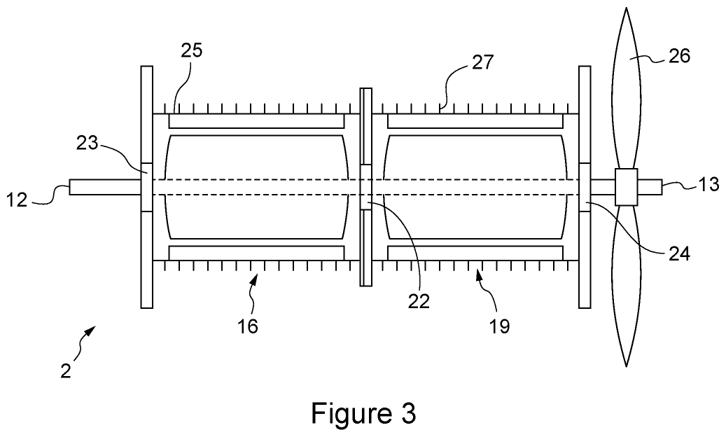

Referring now to FIG. 3, a similar propulsion apparatus 2 is shown. The propulsion apparatus 2 has all the features of the propulsion apparatus 1, but also has additional features to assist with cooling the apparatus and maintaining a stable operating temperature. In particular, the propulsion apparatus 2 further includes a cooling fan 26 which is mounted on the shaft 11 towards the second end 13. The cooling fan 26 will be rotated as the drive motor 16 rotates the shaft 11. To further assist cooling, the housing 25 is also equipped with fins 27. The fins 27 extend radially away from the housing 25 and annularly around the housing 25. The fins 27 are formed integrally with the housing 25 and increase the available surface area of the housing 25 to enhance cooling. In this particular embodiment the housing 25 and fins 27 are composed of an aluminium alloy.

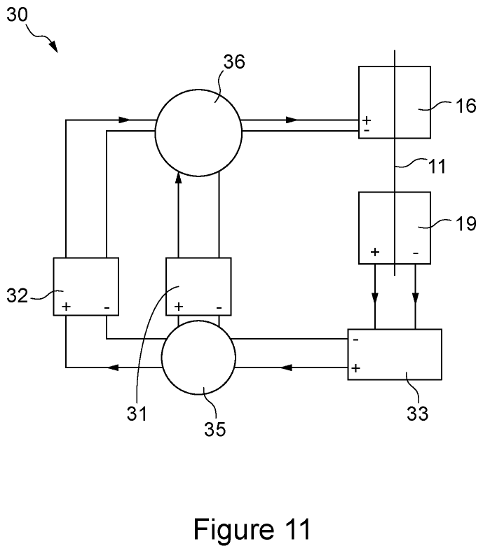

With reference now to FIG. 11, the propulsion apparatus is intended to be connected to an energy supply and storage system 30. The energy supply and storage system includes a first battery bank 31, a second battery bank 32, a battery charger 33 and a control unit 34 comprising a first PCB 35 and a second PCB 36. Although FIG. 11 shows the first and second PCBs 35, 36 as separate components they could be integrated into a single control unit 34. The first and second battery banks 31, 32 are connected to the drive motor 16 via the control unit 34 (second PCB 36). The generator 19 is connected to the first and second battery banks via the battery charger 33 and the control unit 34 (first PCB 35).

The control unit 34 can selectively draw power from either the first battery bank 31 or the second battery bank 32 and provide power to the drive motor 16. The drive motor 16 rotates the shaft 11 which causes the permanent magnet in the rotatable part 20 of the generator 19 to rotate, inducing a current in the armature winding on the fixed part 21. The generated current is then directed through the battery charger 33 to step-up or step-down the voltage as required before being directed to either the first battery bank 31 or the second battery bank 32 by the control unit 34 to recharge the battery bank. When the control unit 34 draws power from the first battery bank 31 then the second battery bank 32 is recharged, and when the control unit 34 draws power from the second battery bank 32 then the first battery bank 31 is recharged.

The first and second battery banks 31, 32 are Li-ion batteries and both have the same size and capacity. The exact size, capacity, type and operating voltage can be selected according to the desired application.

In this particular embodiment, the control unit 34 also includes a first amp hour meter and a second amp hour meter (not shown) which are connected to the first and second battery banks 31, 32 respectively to monitor the amount of charge used from the battery bank and therefore a charge level for the battery bank. The control unit 34 switches between using the first and second battery banks as the driving battery bank (i.e. the battery bank providing drive power to the drive motor 16) when the charge level drops below 25%.

### Test Data

The propulsion apparatus 1 and control unit 34 was tested to determine the effectiveness of the generator 19 at recovering energy from a vehicle drivetrain.

The propulsion apparatus 1 and control unit 34 was mounted to an electric tricycle weighing 35 kg and having 22-inch (55.88 cm) wheels, with the propulsion apparatus 1 replacing a conventional electric motor. The first and second battery banks 31, 32 were each 48 V Li-ion battery packs, each with 13 cells. Such battery packs will charge to a full voltage of 54.6 V. The low voltage cut-off (full discharge) of such batteries is around 39 V. The first battery bank 31 was fully charged to a voltage of 54.6 V before commencing the test. The second battery bank 32 was almost fully discharged to a voltage of 40 V before starting the test.

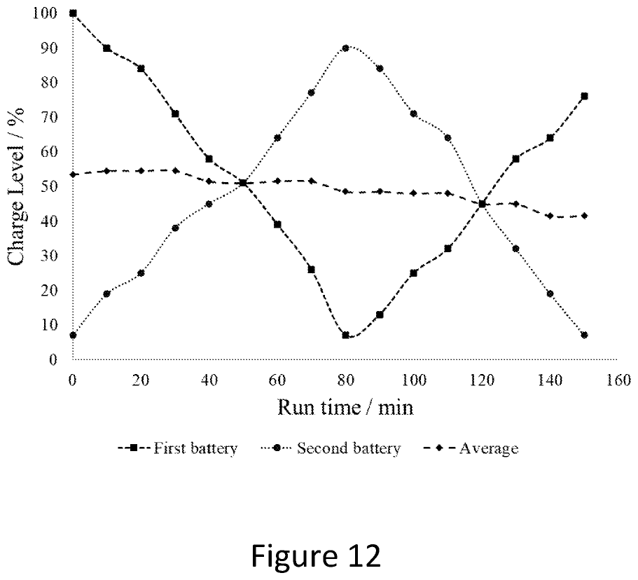

The electric tricycle was then driven at a consistent speed of around 18 mph (28.97 km/h) carrying an adult male weighing 83 kg around an outdoor course on a hard, flat surface. The first battery bank 31 was initially used as the driving battery, with the second battery bank 32 the recharging battery. This was swapped after 80 minutes, with the second battery bank 32 becoming the driving battery and the first battery bank 31 becoming the recharging battery. The charge levels (output voltage) of each battery were measured every 10 minutes. The results are shown in Table 1 and FIG. 12.

TABLE 1
Battery voltages during constant speed test run

| | 1^{st} | 1^{st} | 2^{nd} | 2^{nd} | | |
|---|---|---|---|---|---|---|
| | battery | battery | battery | battery | Average | Average |
| Run time/ | voltage/ | charge/ | voltage/ | charge/ | voltage/ | charge/ |
| min | V | % | V | % | V | % |
| 0 | 54.6 | 100 | 40 | 7 | 47.3 | 53.5 |
| 10 | 53 | 90 | 42 | 19 | 47.5 | 54.5 |
| 20 | 52 | 84 | 43 | 25 | 47.5 | 54.5 |
| 30 | 50 | 71 | 45 | 38 | 47.5 | 54.5 |
| 40 | 48 | 58 | 46 | 45 | 47 | 51.5 |
| 50 | 47 | 51 | 47 | 51 | 47 | 51.0 |
| 60 | 45 | 39 | 49 | 64 | 47 | 51.5 |
| 70 | 43 | 26 | 51 | 77 | 47 | 51.5 |
| 80 | 40 | 7 | 53 | 90 | 46.5 | 48.5 |
| 90 | 41 | 13 | 52 | 84 | 46.5 | 48.5 |
| 100 | 43 | 25 | 50 | 71 | 46.5 | 48 |
| 110 | 44 | 32 | 49 | 64 | 46.5 | 48 |
| 120 | 46 | 45 | 46 | 45 | 46 | 45 |
| 130 | 48 | 58 | 44 | 32 | 46 | 45 |
| 140 | 49 | 64 | 42 | 19 | 45.5 | 41.5 |
| 150 | 51 | 76 | 40 | 7 | 45.5 | 41.5 |

As shown in Table 1 and FIG. 12, over a run time of 150 minutes, the average battery charge level decreases only by 12%, despite the use of 93% of the first battery bank charge capacity and 83% of the second battery bank charge capacity. The propulsion apparatus 1 thus successfully recovers a significant proportion of the driving energy from the vehicle drivetrain for storage in the recharging battery. Even after 150 minutes run time, the first battery bank still has a charge level of 76%, enabling continued use beyond the 150 minutes of the test. This significantly increases the vehicle range compared to a system having only a single drive battery of the same capacity. Comparative experiments using the same electric tricycle carrying the same adult male driven at the same speed by a single 48 V battery were also carried out. The single battery was depleted to the point where it could no longer provide sufficient drive power to the tricycle after 70-90 minutes.

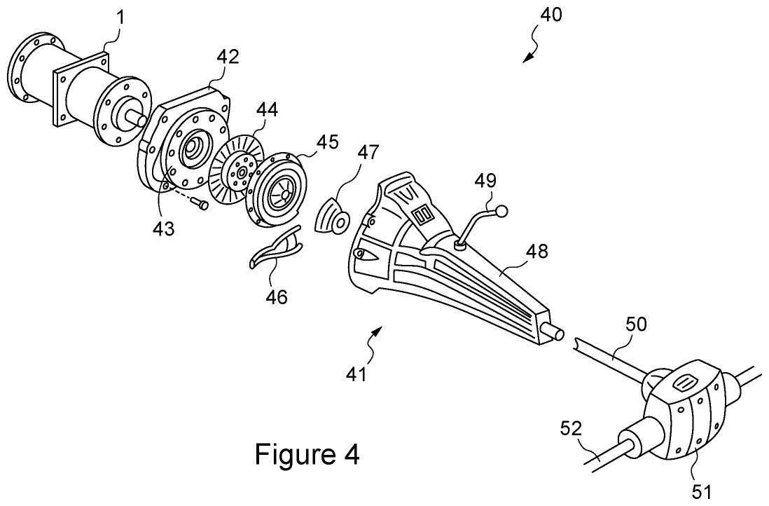

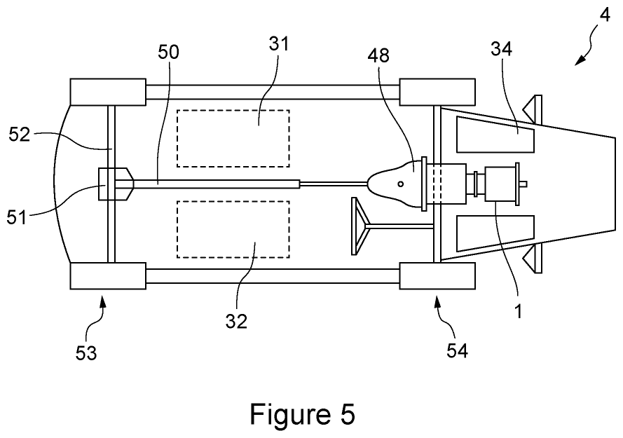

Referring now to FIGS. 4 and 5, the propulsion apparatus 1 (or 2) can be fitted to a road vehicle such as a car 4. The car 4 includes a powertrain 40 made up of the propulsion apparatus 1 and a drivetrain 41. The drivetrain 41 in this particular embodiment is a conventional vehicle drivetrain 41 such as may be found in a front engine rear-wheel drive car. The propulsion apparatus 1 replaces a conventional petrol- or diesel-powered internal combustion engine and is mounted longitudinally within the car 4. It should be noted that the propulsion apparatus 1 could also be mounted transversely (e.g. for a front engine front-wheel drive car) or could be mounted at the rear of the car (e.g. for a rear-engine car) with an appropriate drivetrain 41.

The drivetrain 41 includes a back plate 42 which is mounted between the propulsion apparatus 1 and a clutch assembly. The clutch assembly includes a flywheel 43, clutch plate 44, clutch pressure plate 45, thrust bearing arm 46 and thrust bearing 47. The drivetrain 41 also includes a gearbox 48 having a gear selector 49. It will be appreciated that for an electric car there is no need for a gearbox or transmission system as an electric motor is capable of generating 100% torque at low speeds (unlike an internal combustion engine). However the propulsion apparatus 1 is compatible with the drivetrain 41 of a conventional road vehicle and can therefore be retrofitted to existing petrol or diesel powered road vehicles without a substantial redesign of the drivetrain.

The gearbox 48 is connected to a prop shaft 50 which extends towards the rear end of the car 4 to a differential 51 on a rear (drive) axle 53. In use, the drive motor 16 rotates the shaft 11 which is connected to the clutch assembly and gearbox 48 and prop shaft 50. The prop shaft 50 rotates and in turn rotates the drive shaft 52 on the drive axle 53. The front axle 54 of the car is not actively driven by the powertrain 40.

The car 4 has an energy supply and control system 30 as already described, including first and second battery banks 31, 32 positioned either side of the car 4. The control unit 34 is positioned towards the front of the car 4 in this particular embodiment. The control unit 34 responds to input signals from a throttle control (not shown) such as a throttle/accelerator pedal provided at the driver's seat. The control unit 34 varies the amount of drive power provided to the drive motor 16 from the battery banks 31, 32 in response to the input signal from the throttle control.

As best illustrated by FIG. 11, as the drive motor 16 is powered and turns the shaft 11 and drivetrain 41, the rotatable part 20 of the generator 19 also turns and induces a current in the armature. The generated current is then directed via a battery charger 33 through the control unit 34 and into the first or second battery bank 31, 32. Therefore a portion of the drive power provided to the drive motor 16 can be recovered by the generator 19 and used to recharge the battery banks 31, 32. This increases the range of the car 4.

In the embodiment of FIGS. 4 and 5, the drive motor is a 400V motor and the battery banks are Li-ion batteries, each having a storage capacity of 50 kWh. The car 4 therefore has a total drive battery capacity of 100 kWh.

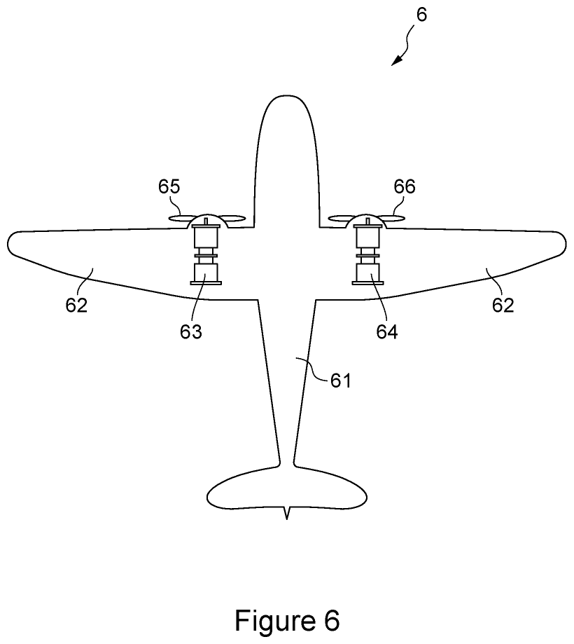

Referring now to FIG. 6, a simplified plan view of a multi-engine fixed wing aircraft 6 with an electric powertrain is shown. With the exception of the powertrain, the aircraft 6 is the same as a conventional propellor driven fixed wing aircraft. In this particular embodiment, the fixed wing aircraft 6 is a light aircraft intended for passenger transport having a maximum gross takeoff weight of 12500 lbs. The aircraft 6 has a fuselage 61 and wings 62. The aircraft 6 is powered by two engines: a first engine 63 provided on the port wing and a second engine 64 provided on the starboard wing. The aircraft 6 is a propellor driven aircraft, with the first and second engines 63, 64 operable to rotate first and second propellors 65, 66 respectively.

The first and second engines 63, 64 each consist of a propulsion apparatus 1 as hereinbefore described. The shaft 11 of each of the first and second engines 63, 64 is connected directly to the first and second propellors 65, 66 respectively. Each engine 63, 64 has an energy supply and storage system 30 (not shown) comprising first and second battery banks 31, 32, battery charger 33 and control unit 34. These components of the energy supply and storage system 30 are provided in the fuselage 61. The control units 34 for each of the first and second engines 63, 64 respond to input signals from a power control (not shown) such as a throttle lever provided in the cockpit. The control unit 34 varies the amount of drive power provided to the drive motors 16 on the engines 63, 64 from the battery banks 31, 32 in response to the input signal from the power control.

As best illustrated by FIG. 11, as the drive motor 16 is powered and turns the shaft 11 and propellors 65, 66, the rotatable part 20 of the generator 19 also turns and induces a current in the armature. The generated current is then directed via a battery charger 33 through the control unit 34 and into the first or second battery bank 31, 32. Therefore a portion of the drive power provided to the engines 63, 64 can be recovered by the generator 19 and used to recharge the battery banks 31, 32. This increases the range of the aircraft 6.

Although the engines 63, 64 have the same construction as the propulsion apparatus 1 used in the car 4, the power rating of the drive motor and battery banks is different for the aircraft 6. In the embodiment of FIG. 6, the drive motor is a 700V motor and the battery banks are Li-ion batteries, each having a storage capacity of 30 kWh. The aircraft 6 therefore has total drive battery capacity of 120 kWh.

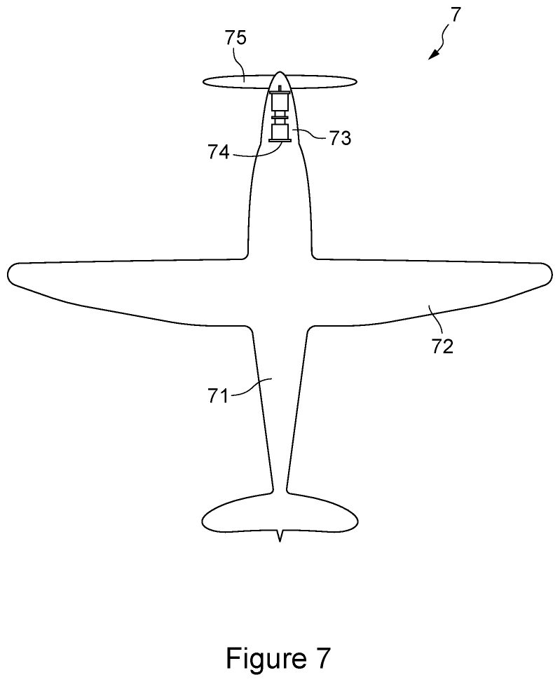

Referring now to FIG. 7, a simplified plan view of a single-engine fixed wing aircraft 7 with an electric powertrain is shown. With the exception of the powertrain, the aircraft 7 is the same as a conventional single-engine propellor driven fixed wing aircraft. In this particular embodiment, the fixed wing aircraft 7 is a light aircraft intended for recreational use having a maximum gross take off weight of approximately 3500 lbs. The aircraft 7 has a fuselage 71 and wings 72. The aircraft 7 is powered by a single engine 74 mounted in the nose 73 of the aircraft. The engine 74 drives a nose mounted propellor 75.

The engine 74 is identical in construction to the propulsion apparatus 1. The shaft 11 of the engine 74 is connected directly to the propellor 75. The engine 74 has an energy supply and storage system 30 (not shown) comprising first and second battery banks 31, 32, battery charger 33 and control unit 34. These components of the energy supply and storage system 30 are provided in the fuselage 71. The control unit 34 of the energy supply and storage system 30 responds to input signals from a power control (not shown) such as a throttle lever provided in the cockpit. The control unit 34 varies the amount of drive power provided to the engine 74 from the battery banks 31, 32 in response to the input signal from the power control.

As best illustrated by FIG. 11, as the drive motor 16 is powered and turns the shaft 11 and the propellor 75, the rotatable part 20 of the generator 19 also turns and induces a current in the armature. The generated current is then directed via a battery charger 33 through the control unit 34 and into the first or second battery bank 31, 32. Therefore a portion of the drive power provided to the engine 74 can be recovered by the generator 19 and used to recharge the battery banks 31, 32. This increases the range of the aircraft 7.

Although the engine 74 has the same construction as the propulsion apparatus 1 used in the car 4, the power rating of the drive motor and battery banks is different for the aircraft 7. In the embodiment of FIG. 7, the drive motor is a 700V motor and the battery banks are Li-ion batteries, each having a storage capacity of 20 kWh. The aircraft 7 therefore has total drive battery capacity of 40 kWh.

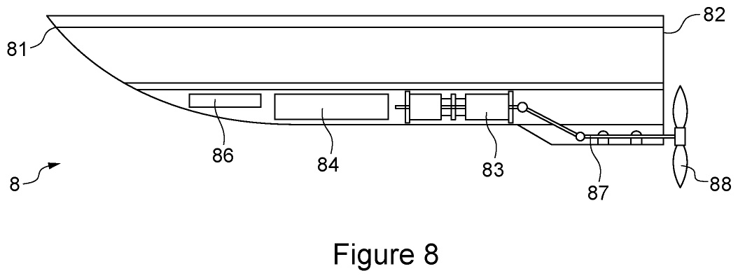

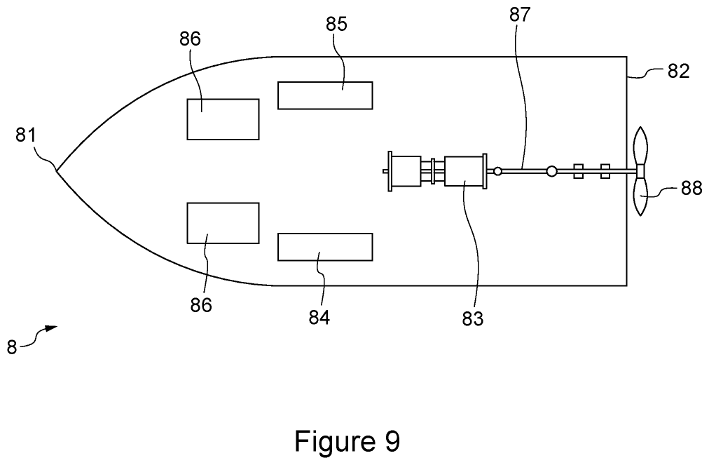

Referring now to FIGS. 8 and 9, a boat 8 is shown. The boat 8 is a small watercraft such as a motor launch. The boat 8 has a bow 81 and a stern 82 and is powered by an electric engine 83 mounted within the hull of the boat. The electric engine 83 is identical in construction to the propulsion apparatus 1. The shaft 11 of the electric engine 83 is connected directly to a driveshaft 87 which is connected to a propellor 88 at the stern 82.

The electric engine 83 has an energy supply and storage system comprising first and second battery banks 84, 85 battery charger (not shown) and control unit 86. The first battery bank 84 is mounted on the port side of the boat 8, and the second battery bank 85 is mounted on the starboard side. The control unit 86 of the energy supply and storage system responds to input signals from a power control (not shown) such as a throttle lever provided in the cockpit. The control unit 86 varies the amount of drive power provided to the drive motor 16 from the battery banks 31, 32 in response to the input signal from the power control.

As best illustrated by FIG. 11, as the drive motor 16 is powered and turns the shaft 11, driveshaft 87 and the propellor 88, the rotatable part 20 of the generator 19 also turns and induces a current in the armature. The generated current is then directed via a battery charger 33 through the control unit 86 and into the first or second battery bank 84, 85. Therefore a portion of the drive power provided to the electric engine 83 can be recovered by the generator 19 and used to recharge the battery banks 84, 85. This increases the range of the boat 8.

Although the electric engine 83 has the same construction as the propulsion apparatus 1 used in the car 4, the power rating of the drive motor and battery banks is different for the boat 8. In the embodiment of FIGS. 8 and 9, the drive motor is a 48V motor and the battery banks are Li-ion batteries, each having a storage capacity of 20 kWh. The boat 8 therefore has total drive battery capacity of 40 kWh.

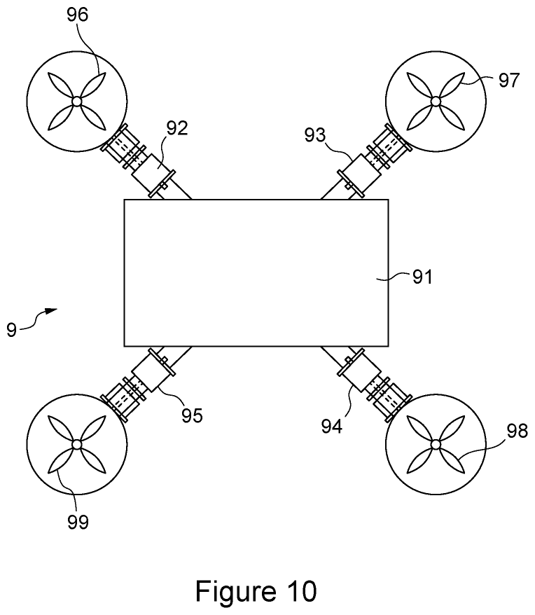

Referring now to FIG. 10, a rotary wing aircraft 9 is shown. In this particular embodiment, the rotary wing aircraft 9 is a quadrotor-type helicopter having a main body 91 and four rotor arms which extend radially from the central body 91 and are spaced at right angles so that each rotor arm is positioned diametrically opposite another rotor arm. At the distal end of each rotor arm is a propellor 96, 97, 98, 99. The four propellors 96, 97, 98 and 99 are horizontally mounted and are coplanar and rotate about parallel axes (not shown). The first and third propellors 96, 98 are positioned diametrically opposite each other and are configured to rotate in a clockwise direction whilst the second and fourth propellors 97, 99 are positioned diametrically opposite each other and are configured to rotate in a counter-clockwise direction.

Each rotor arm is provided with a propulsion apparatus 92, 93, 94, 95 which drives the propellors 96, 97, 98, 99 respectively. The propulsion apparatuses 92, 93, 94, 95 are identical to propulsion apparatus 1. The propulsion apparatuses 92, 93, 94 and 95 are each connected to a central energy supply and storage system 30. The central energy supply and storage system is similar to the system shown in FIG. 11, however the control unit is connected to each of the four drive motors 16 and to each of the generators 19. The control unit 34 (not shown) of the energy supply and storage system 30 can independently direct power from the first or second battery bank 31, 32 to each or all of the four drive motors 16 in response to a control input. For example, for vertical lift or hovering, the control unit 34 will direct the same amount of power to each of the four propulsion apparatuses 92, 93, 94, 95. To turn (adjust yaw), the control unit 34 will direct more power to either the first and third propulsion apparatus 92, 94 or the second and fourth propulsion apparatus 93, 95. To adjust pitch or roll, the control unit 34 will direct more power to a single propulsion apparatus.

As the drive motors 16 turn the shafts 11 of each of the four propulsion apparatuses, the rotatable part 20 of each generator 19 also turns and induces a current in the armature. The generated current is then directed via a battery charger 33 through the control unit 34 and into the first or second battery bank 31, 32. Therefore a portion of the drive power provided to each propulsion apparatus can be recovered by the generators 19 and used to recharge the battery banks 31, 32. This increases the range of the rotary wing aircraft 9.

Although each propulsion apparatus 92, 93, 94, 95 has the same construction as the propulsion apparatus 1 used in the car 4, the power rating of the drive motor and battery banks is different for the rotary wing aircraft 9. In the embodiment of FIG. 10, the drive motors are 700V motors and the batteries are Li-ion batteries, each having a storage capacity of 50 kWh. The aircraft 9 therefore has total drive battery capacity of 100 kWh.

1. Propulsion apparatus for an electric vehicle, comprising:
a drive motor having a rotor mounted on and extending annularly around a motor shaft, and a stator spaced apart from the rotor and extending annularly around the rotor and at least a portion of the motor shaft, wherein the motor shaft has a first end, a second end and a longitudinal axis extending therebetween and is connectable to a drivetrain of a vehicle;
a generator having a rotatable part mounted on and extending annularly around a generator shaft, and a fixed part spaced apart from the rotatable part and extending annularly around the rotatable part and at least a portion of the generator shaft, wherein the generator shaft has a first end, a second end and a longitudinal axis extending therebetween and is connected to and is driveable by the motor shaft, and wherein either the rotatable part or the fixed part is capable of generating a magnetic field, and an armature is provided on the alternate fixed part or rotatable part; and
a support structure to support the drive motor, the generator, the motor shaft and the generator shaft, wherein the stator and the fixed part are mounted to the support structure and the support structure includes one or more bearings to support and limit lateral movement of the motor shaft and generator shaft.

2. The propulsion apparatus of claim 1, wherein the second end of the motor shaft is connected to the first end of the generator shaft such that the motor shaft and generator shaft are coaxial.

3. The propulsion apparatus of claim 2, wherein the motor shaft and generator shaft are a single unitary elongate body comprising a motor shaft portion and a generator shaft portion.

4. The propulsion apparatus of claim 1, wherein the support structure includes a magnetic field shield positioned between the motor and the generator.

5. The propulsion apparatus of claim 1, wherein the generator is a permanent magnet generator with either the rotatable part or the fixed part comprising a permanent magnet and the alternate part providing the armature.

6. The propulsion apparatus of claim 1, further comprising a fan attached to either the motor shaft or the generator shaft.

7. The propulsion apparatus of claim 1, wherein the support structure is a housing to house the drive motor, generator and at least a portion of the motor shaft and the generator shaft.

8. The propulsion apparatus of claim 7, wherein the housing has one or more heat sinks on an external surface, the heat sinks comprising one or more fins extending radially outwards from the external surface.

9. The propulsion apparatus of claim 1, further comprising an energy supply and storage system which comprises:
a first battery bank;
a second battery bank; and
a control unit electrically connected to the first battery bank, the second battery bank, the drive motor, the generator, and connectable to a throttle control; wherein the control unit can direct electrical power from one of the first battery bank or the second battery bank to the drive motor in response to a power demand signal from the throttle control, and can simultaneously direct electrical power from the generator into the alternate battery bank.

10. The propulsion apparatus of claim 1, wherein the generator is a DC generator and further comprises a mechanical or electronic commutator which is electrically connected to the armature to convert the current generated in the armature to direct current.

11. The propulsion apparatus of claim 9, wherein the generator is an AC generator and the propulsion apparatus further comprises a rectifier electrically connected between the generator and the control unit to convert the generated alternating current to direct current.

12. The propulsion apparatus of claim 9, wherein the drive motor is an AC motor and the propulsion apparatus further comprises an inverter electrically connected between the control unit and the drive motor to convert the direct current from the battery bank to alternating current.

13. The propulsion apparatus of claim 9, wherein the control unit includes:
a first amp hour meter to determine a charge level for the first battery bank; and a second amp hour meter to determine a charge level for the second battery bank; wherein the control unit is configured to be switchable between a first operational mode wherein the first battery bank provides power to the drive motor and the second battery bank is charged by the generator, and a second operational mode wherein the second battery bank provides power to the drive motor and the first battery bank is charged by the generator, when the charge level in the battery bank providing power to the drive motor reaches a predetermined value as detected by one of the amp hour meters.

14. An electric vehicle having a powertrain which includes:
a propulsion apparatus comprising a drive motor mounted on a motor shaft, wherein the motor shaft has a first end, a second end and a longitudinal axis extending therebetween; a generator mounted on a generator shaft, wherein the generator shaft has a first end, a second end and a longitudinal axis extending therebetween and is connected to and is driveable by the motor shaft; and a support structure to support the drive motor, the generator, the motor shaft and the generator shaft, wherein the support structure includes one or more bearings to support and limit lateral movement of the motor shaft and generator shaft; and a drivetrain connected to and driveable by the motor shaft.

15. The electric vehicle of claim 14, wherein the second end of the motor shaft is connected to the first end of the generator shaft such that the motor shaft and generator shaft are coaxial.

16. The electric vehicle of claim 15, wherein the motor shaft and generator shaft are a single unitary elongate body comprising a motor shaft portion and a generator shaft portion.

17. The electric vehicle of claim 14, further comprising:
an energy supply and storage system, wherein the energy supply and storage system comprises:
a first battery bank;
a second battery bank; and
a control unit electrically connected to the first and second battery banks, the drive motor, the generator and a throttle control provided on the vehicle;
wherein the control unit can direct power from one of the battery banks to the drive motor in response to an input from the throttle control whilst simultaneously directing power from the generator to the alternate battery bank.

18. The electric vehicle of claim 14, wherein the vehicle is a land-based vehicle, a marine vessel, or an aircraft.

19. The electric vehicle of claim 14, wherein the electric vehicle is a land-based vehicle having at least one drive axle and the drivetrain comprises a prop shaft which is connected to and is driveable by the motor shaft and extends longitudinally with respect to the vehicle from the propulsion apparatus to a differential at the drive axle.

20. The electric vehicle of claim 19, wherein the prop shaft and the motor shaft are coaxial.

21. The electric vehicle of claim 14, wherein the electric vehicle is a land-based vehicle having at least one drive axle and the drivetrain comprises a transmission which is connected to and is drivable by the motor shaft.

22. An energy supply and storage system for an electric vehicle, comprising:
a first battery bank;
a second battery bank; and
a control unit electrically connected to the first battery bank and the second battery bank, wherein the control unit also includes a power output port, a power input port and a controller port;
wherein in use the control unit can direct electrical power from one of the first battery bank or the second battery bank to the power output port in response to a demand signal from a controller connected to the controller port, and can simultaneously direct electrical power from the power input port into the alternate battery bank.

23. The energy supply and storage system of claim 22, wherein the control unit includes:
a first amp hour meter to determine a charge level for the first battery bank; and a second amp hour meter to determine a charge level for the second battery bank; wherein the control unit is switchable between a first operational mode wherein the first battery bank provides power to the power output port and the second battery bank receives power for recharging from the power input port, and a second operational mode wherein the second battery bank provides power to the power output port and the first battery bank receives power for recharging from the power input port, when the power remaining level in the battery bank providing power reaches a predetermined value.
